(19) United States
(12) Patent Application Publication
(10) Pub. No.: US 2024/0394565 A1
(43) Pub. Date: Nov. 28, 2024

(54) GENERATING RULES FOR PREDICTING CHARACTERISTICS OF COMPUTER OPERATIONS

(71) Applicant: PayPal, Inc., San Jose, CA (US)

(72) Inventors: Xuan Lu, Shanghai (CN); Xuan Li, Shanghai (CN)

(21) Appl. No.: 18/454,417

(22) Filed: Aug. 23, 2023

(30) Foreign Application Priority Data
May 23, 2023 (WO) PCT/CN2023/095750

(51) Int. Cl. G06N 5/022

(52) U.S. Cl. CPC G06N 5/022

(57) ABSTRACT

Techniques are disclosed that relate to generating a rule for performing predictions of a characteristic of computer operations. A computer system may receive historical data that describes executed computer operations, including variables associated with those executed computer operations, and user input specifying desired properties of the performed predictions. The computer system determines, for a given variable, bins having ranges specified using the variable. The bins may be formed such that, when the executed computer operations are grouped into the bins, a prevalence of the characteristic monotonically increases or decreases from bin to bin across a bin ordering that is based on the ranges. The computer system then determines one or more cutoffs for one or more of the variables based on the desired properties from user's inputs and the determined bins. The computer system generates the rule based on the one or more cutoffs and the one or more variables.

### PRIORITY CLAIM

The present application claims priority to PCT Appl. No. PCT/CN2023/095750, entitled “GENERATING RULES FOR PREDICTING CHARACTERISTICS OF COMPUTER OPERATIONS”, filed May 23, 2023, which is incorporated by reference herein in its entirety.

### BACKGROUND

### Technical Field

This disclosure relates generally to computer systems and, more specifically, to various mechanisms for generating rules for predicting characteristics of computer operations.

### Description of the Related Art

Enterprises are increasingly utilizing machine learning to enhance the services that they provide to their users. Using machine learning techniques, a computer system can train models from existing data and then use them to identify similar trends in new data. In some cases, the training process is supervised in which the computer system is provided with labeled data that it can use to train a model. For example, a model for identifying spam can be trained based on emails that are labeled as either spam or not spam. Examples of supervised learning algorithms include linear regression, logistic regression, and support vector machines. In other cases, the training process can be unsupervised in which the computer system is provided with unlabeled data that it can use to train a model to discover underlying patterns in that data. Unsupervised training may be favored in scenarios in which obtaining labeled data is difficult, costly, and/or time-consuming.

### BRIEF DESCRIPTION OF THE DRAWINGS

FIG. 1 is a block diagram illustrating example elements of a system having a computer operation system and a rule generation system that is capable of generating a rule for predicting a characteristic of computer operations, according to some embodiments.

FIG. 2 is a block diagram illustrating example steps performed by a rule generation system to generate a rule for predicting a characteristic of computer operations, according to some embodiments.

FIG. 3 is a block diagram illustrating example elements of a preprocess module that is capable of extracting and selecting variables from historical data to be used to generate a rule, according to some embodiments.

FIGS. 4A-B are chart diagrams illustrating example elements of monotonic binning that results in a monotonic relationship between a variable and a characteristic, according to some embodiments.

FIG. 5A is a block diagram illustrating example elements of a rule module capable of generating a rule, according to some embodiments.

FIG. 5B is a block diagram illustrating an example cutoff process in which cutoffs are determined for various variables, according to some embodiments.

FIG. 5C is a block diagram illustrating an example optimization process in which cutoffs are adjusted, according to some embodiments.

FIG. 6 is a block diagram illustrating example elements of a system capable of applying a rule for predicting computer operation requests, according to some embodiments.

FIG. 7 is a block diagram illustrating an example method that relates to generating a rule for performing predictions of a characteristic of computer operations, according to some embodiments.

FIG. 8 is a block diagram illustrating another example method that relates to generating a rule for performing predictions of a characteristic of computer operations, according to some embodiments.

FIG. 9 is a block diagram illustrating elements of a computer system for implementing various systems described in the present disclosure, according to some embodiments.

### DETAILED DESCRIPTION

Computer systems can perform different types of computer operations, often on behalf of users. Some of those computer operations can be detrimental to the computer systems and/or the users if they exhibit certain characteristics. For example, a database transaction, performed on behalf of one user, that exhibits high resource usage (a characteristic) might cause other database transactions, performed on behalf of other users, to run slower. As another example, network traffic that exhibits abnormal behavior (e.g., an unusual request being received at a database) might be indicative of a malicious actor infiltrating a computer system and causing adverse or otherwise negative effects. It may thus be desirable to generate criteria or rules that can be used to detect or predict whether a particular computer operation will exhibit a certain characteristic that is undesired as this may allow for the computer operation to be prevented. Machine learning techniques represent a mechanism that can be used in a process to generate a rule by facilitating the generation of a model that may be used to recognize or predict characteristics of computer operations or even data (e.g., duplicate records).

Conventional approaches that are based on machine learning techniques, however, may be deficient for various reasons. First, conventional approaches lack the capability to deal with different types of variables in a unified way and thus tend to rely on utilizing only one type of variable, usually a model score (which may be a value produced by a trained machine learning algorithm). But training data commonly includes different types of variables, such as numerical variables, character variables, and model scores. As such, conventional approaches do not fully utilize the information in existing training data. Second, conventional approaches do not generate rules or criteria that adequately leverage the available user domain knowledge but instead rely heavily upon statistical measurements, such as entropy and Gini coefficients, to produce their outputs. As a result, those outputs may not be as operable in achieving the desired outcome. Third, conventional approaches do not provide a mechanism for a user to leverage existing domain knowledge in order to add, modify, and remove constraints during a rule generating process. This disclosure addresses, among other things, the problem of how to generate a rule for detecting or predicting the computer operations with certain characteristic(s) while overcoming some or all of the above deficiencies of conventional approaches.

In various embodiments described below, a system comprises a rule generation system that can generate rules for performing predictions of characteristics of computer operations and a computer operation system that performs the computer operations. As part of generating one or more rules, in various embodiments, the rule generation system receives historical data that describes executed computer operations (including variables associated with those operations) and user input that specifies desired properties (e.g., a correct prediction rate) of the predictions performed by the one or more rules. The rule generation system may initially preprocess (e.g., normalize) the received historical data and select, using the historical data and based on the user input, a subset of variables based on their predictive power and propensity for monotonic binning. For a given selected variable, in various embodiments, the rule generation system then performs a binning operation in which it determines bins having ranges that are specified using the given selected variable. Those bins are determined such that, when the executed computer systems are placed into the bins, the prevalence of the characteristic for which the one or more are rules are being generated monotonically increases or decreases from bin to bin across a bin ordering that is based on the ranges. After the selected variables are monotonically binned, in various embodiments, the rule generation system performs one or more rounds of determining cutoffs for the binned variables that attempt to balance between the desired properties that are specified in the user input-this process may be repeated until those desired properties are satisfied and may also use machine learning techniques. One or more variables and their cutoffs may then be used by the rule generation system to derive a rule.

In some cases, multiple candidate rules may be derived from a combination of different variables and cutoffs and a user may select one or more of the candidate rules to use at the computer operation system. In some cases, the rule generation system may perform an optimization on a rule to attempt to improve it by adjusting one or more of its cutoffs. After the one or more rules have been generated, the rule generation system may provide those rules to the computer operation system to enable it to perform predictions of certain computer operations to decide whether to execute those computer operations.

These techniques may be advantageous over prior approaches as these techniques allow rules for predicting characteristics of computer operations to be generated in a rule generation process that can handle different types of variables and incorporate user domain knowledge at different steps in the process. For example, a user can define the characteristic(s) for which to generate a set of rules and constraints or properties of those rules, and the user can also select variables to be used in the process, the number of rules to be generated, and the rule(s) that are ultimately used. As a result, a user can influence the rule generation process using their domain knowledge such that the rules that are generated are better suited to the user's objectives. Also, the monotonic binning techniques discussed in this disclosure allow different types of variables (e.g., binary variables, continuous variables, positive-oriented variables, etc.) to be represented in a common, unified format. Consequently, different types of variables can be used to generate rules in a unified and consistent way that may be better suited to the user's objectives. Furthermore, by being able to generate rules to predict characteristics of computer operations, the operation of a computer system can be improved by preventing computer operations that are time consuming to perform, resource intensive, and/or cause adverse or otherwise negative effects to the computer system.

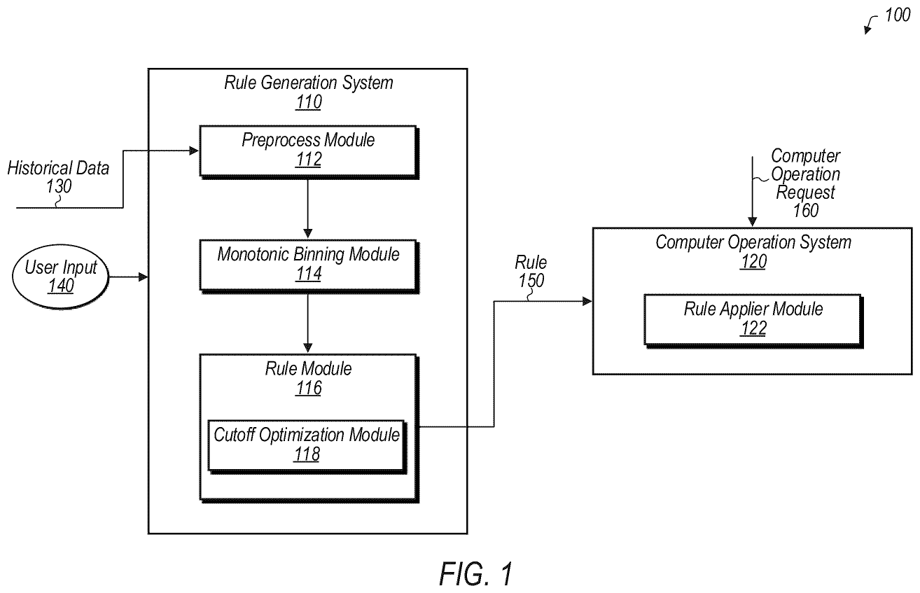

Turning now to FIG. 1, a block diagram of a system 100 is shown. System 100 includes a set of components that may be implemented via hardware or a combination of hardware and software. In the illustrated embodiment, system 100 includes a rule generation system 110 and a computer operation system 120. As shown, rule generation system 110 includes a preprocess module 112, a monotonic binning module 114, and a rule module 116, and computer operation system 120 includes a rule applier module 122. As further shown, rule generation system 110 receives historical data 130 and user input 140, and computer operation system 120 receives a rule 150 and a computer operation request 160. In some cases, the illustrated embodiment may be implemented differently than shown. As an example, systems 110 and 120 may be the same system-e.g., rule generation system 110 may include rule applier module 122 and thus apply rules 150 that it generates.

System 100, in various embodiments, is a platform that provides one or more services (e.g., a cloud computing service, a customer relationship management service, and a payment processing service) that are accessible to users that can invoke functionality of the services to achieve a user-desired objective. In order to facilitate the functionality of those services, system 100 may execute various software routines, such as rule applier module 122, as well as provide code, web pages, and other data to users, databases, and other entities that use system 100. In various embodiments, system 100 is implemented using a cloud infrastructure that is provided by a cloud provider. Components of rule generation system 110 and computer operation system 120 may thus execute on and utilize the available cloud resources of that cloud infrastructure (e.g., computing resources, storage resources, etc.) to facilitate their operation. As an example, software that is executable to implement functionality of preprocess module 112 may be stored on a non-transitory computer-readable medium of server-based hardware that is included in a datacenter of the cloud provider. That software may be executed within a virtual environment that is hosted on the server-based hardware. In some embodiments, system 100 is implemented using a local or private infrastructure as opposed to a public cloud.

Rule generation system 110, in various embodiments, is a system that generates rules 150 for predicting characteristics of computer operations, which can be performed by computer operation system 120. A computer operation may be of any type of operation that is facilitated by computer systems-examples of different types of computer operations include, but are not limited to, database transactions, payment transactions, authentication/verification operations, and network routing operations (e.g., downloads). Different types of computer operations may be associated with different characteristics. As an example, a database transaction may be high resource intensive or low resource intensive while a payment transaction may be authentic or fraudulent. Rule 150, in various embodiments, specifies a set of criteria that, if satisfied by a particular type of computer operation, predicts that the computer operation will exhibit one or more characteristics when executed-in some cases, rule 150 is used to predict characteristics of data (e.g., duplicate records). As an example, rule 150 might specify “variable A>0.950 & variable B>115” and thus a computer operation (e.g., a database transaction) that corresponds to rule 150 is predicted to exhibit certain characteristics (e.g., will fail) if its values for variables A and B are greater than 0.950 and 115, respectively.

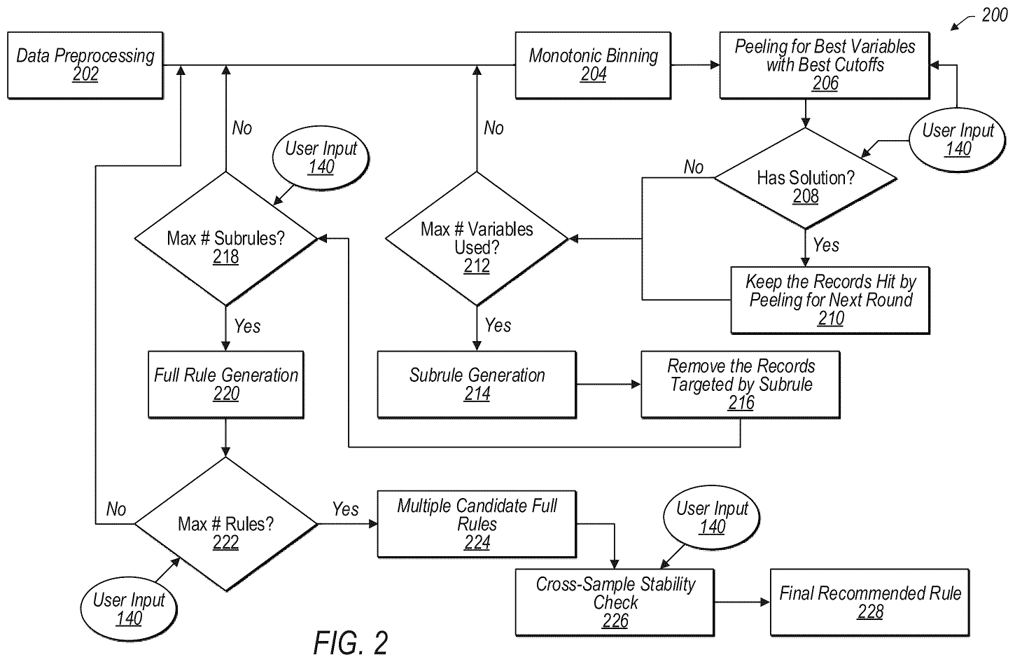

To facilitate the generation of rule 150, rule generation system 110 receives historical data 130 and user input 140, both of which may be received from a database, a user interface, another, separate computer system, etc. Historical data 130, in various embodiments, describes previously executed computer operations, including variables (the structured representations of the information in historical data 130) and/or outcomes associated with those executed computer operations. For example, historical data 130 may include information on past database transactions, such as memory usage, central processing unit (CPU) usage, the number of records touched by those database transactions, their execution time, whether those database transactions failed or succeed, etc. In some embodiments, computer operation system 120 tracks information about the computer operations that it performs and provides or stores the information as historical data 130 so that it can be used by rule generation system 110. User input 140, in various embodiments, includes information provided by a user that can be used to control the generation of rule 150 in order to improve the quality and relevance of rule 150 to the user's objectives. For example, a user may determine the maximal number of variables used in generating rule 150. As discussed in greater detail with respect to FIG. 2, user input 140 can take various forms and be received at different stages of the rule generation process.

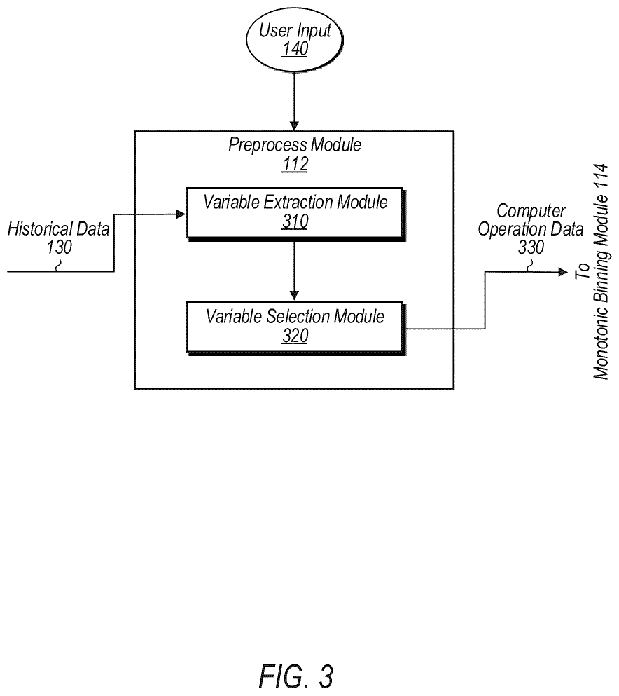

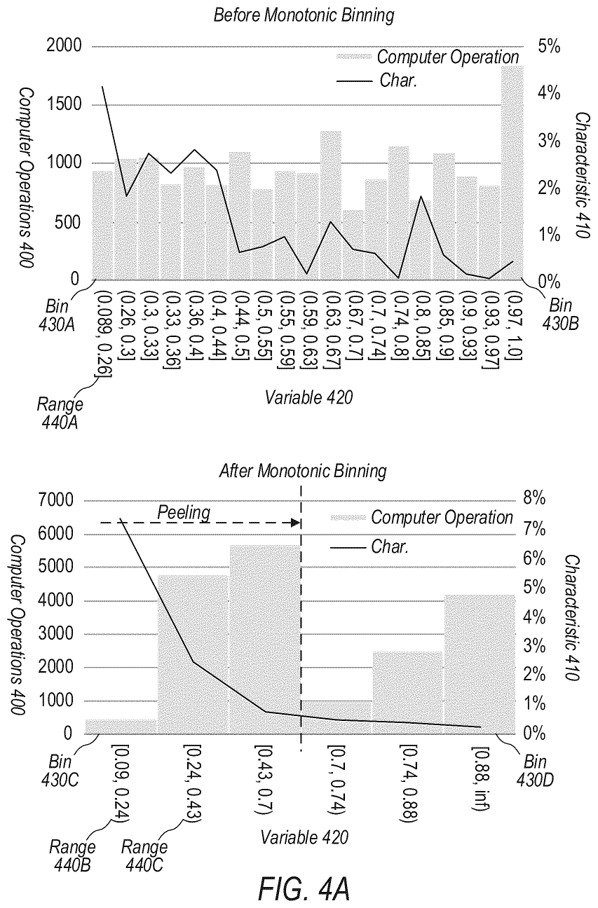

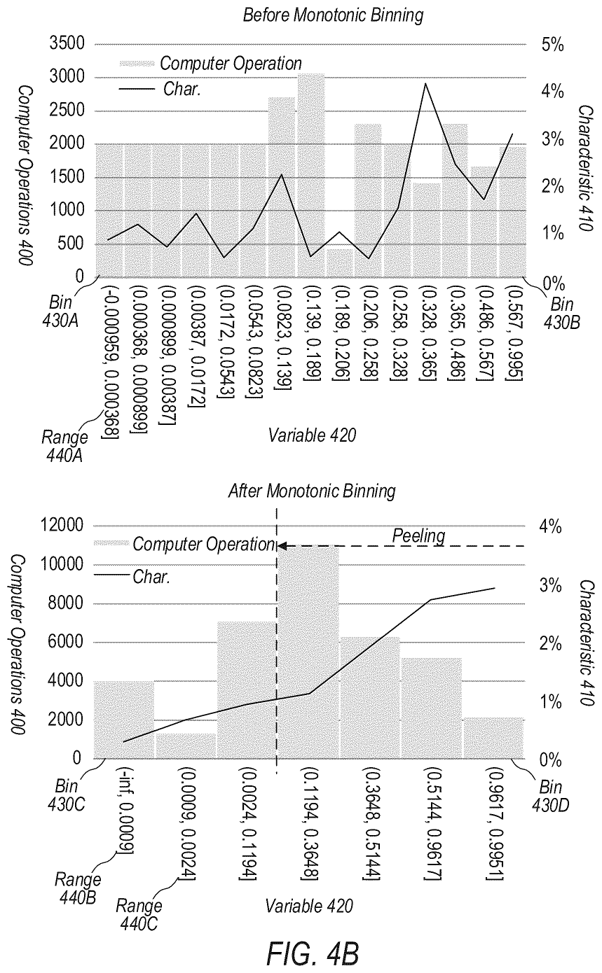

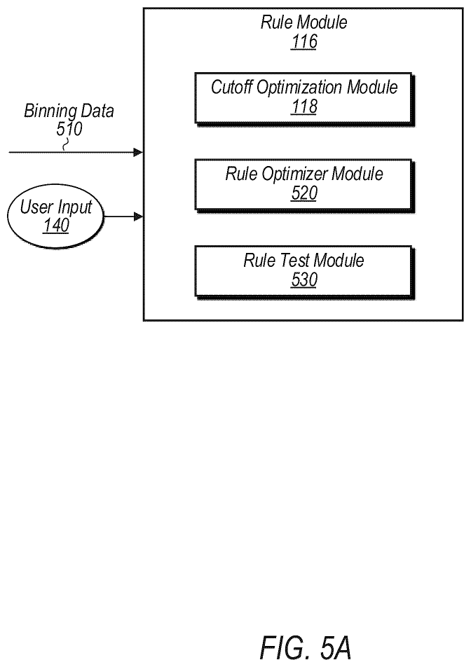

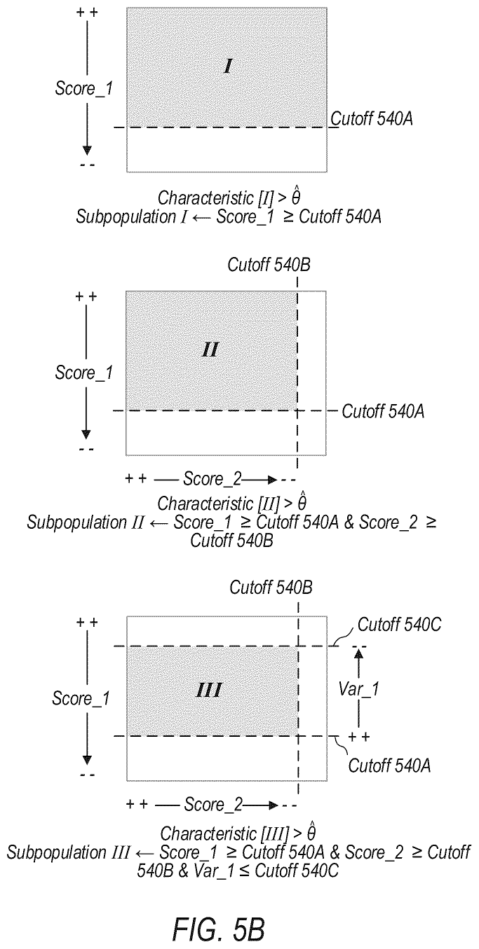

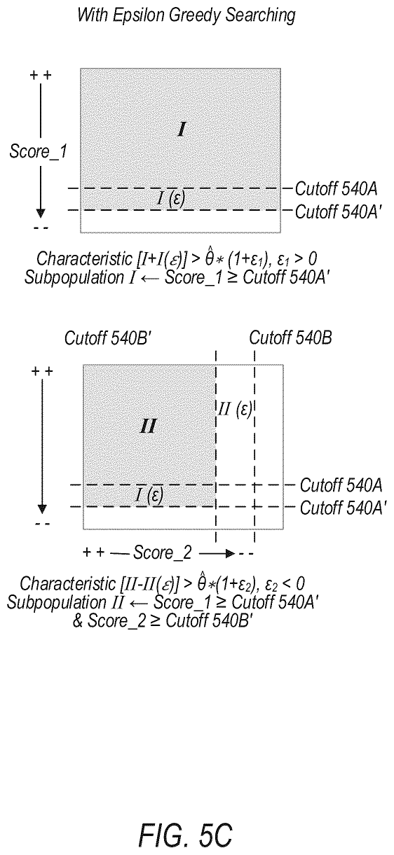

The generation of rule 150 can involve the use of various software modules. As shown, rule generation system 110 comprises preprocess module 112, monotonic binning module 114, and rule module 116. Preprocess module 112, in various embodiments, is software executable to receive and prepare historical data 130 for use in a monotonic binning process performed by monotonic binning module 114. Preprocess module 112 may implement one or more data preprocessing techniques on historical data 130, such as normalization, high missing deletion, population stability index (PSI) calculation, and information value (IV) calculation, to extract and select one or more candidate variables based on their predicted ability to facilitate the generation of rule 150 such that it satisfies user input 140. Preprocess module 112 is discussed in greater detail with respect to FIG. 3. Monotonic binning module 114, in various embodiments, is software executable to perform the monotonic binning process in which bins are generated, for a given variable, that have ranges into which the computer operations are divided based on their values for the given variable. Monotonic binning module 114 adjusts or combines the ranges of those bins until a monotonic relationship (positive or negative) is established between the variable and a prevalence of the specified characteristic. After generating the bins, monotonic binning module 114 provides information about them to rule module 116. Monotonic binning module 114 is discussed in greater detail with respect to FIGS. 4A-B. Rule module 116, in various embodiments, is software executable to generate and apply cutoffs to the binned variables, using cutoff optimization module 118, in order to generate one or more rules 150. Rule module 116 may attempt to find a version of those rules 150 having higher propensity to achieve a user's goal by randomly shifting the position of the cutoffs to generate alternative rules 150 based on user input. Using existing computer operation data, rule module 116 may score each rule 150 and suggest a particular rule 150 to use. Rule module 116 is discussed in greater detail with respect to FIGS. 5A-C. After identifying a particular rule 150 to use, rule module 116 may provide that particular rule 150 to computer operation system 120.

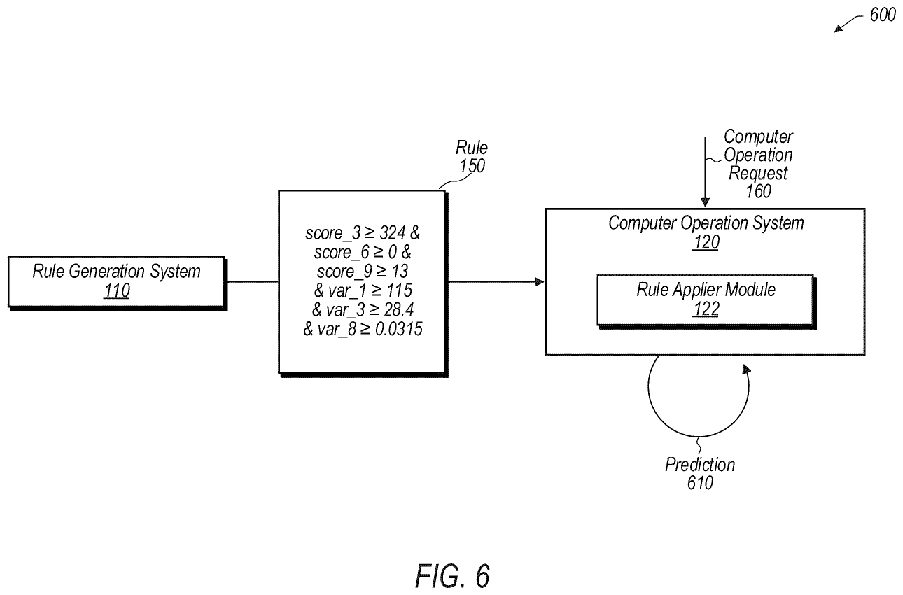

Computer operation system 120, in various embodiments, is a system that can perform different types of computer operations (e.g., database operations, payment operations, etc.) as requested (e.g., in response to receiving computer operation request 160). Before performing a computer operation, in various embodiments, computer operation system 120 may apply rule 150, using rule applier module 122, to predict whether the computer operation will exhibit the characteristic(s) when executed. Computer operation system 120 may utilize one or more rules 150 to determine whether or not to execute a given computer operation. If a computer operation is predicted to exhibit the characteristic(s), then, in various cases, computer operation system 120 does not execute that computer operation. Computer operation system 120 is discussed in greater detail with respect to FIG. 6.

Turning now to FIG. 2, a block diagram of an example of a rule generation process 200 that is performed by rule generation system 110 is shown. In the illustrated embodiment, rule generation process 200 begins with step 202 in which received historical data 130 is processed using preprocess module 112. Preprocess module 112 may extract or derive variables based on historical data 130, select a portion or all of the variables based on an analysis, and then provide them to monotonic binning module 114 in a form suitable for monotonic binning in step 204. As discussed in greater detail with respect to FIGS. 4A-B, in various embodiments, monotonic binning module 114 performs a binning operation on the variables by continually creating or adjusting bins for a given variable until a monotonic relationship is created between the given variable and the user-specified characteristic(s) for which rule 150 is being generated.

Binning information about the given variable and its bins is provided to cutoff optimization module 118 to generate cutoffs in step 206. As discussed in more detail with respect to FIG. 5B, in various embodiments, cutoff optimization module 118 performs multiple peeling rounds to search for the best variables with corresponding cutoffs that satisfy the set of properties/constraints identified by user input 140-the identified variable is referred to as the “best variable” for that peeling round and may be deemed best by a machine learning model. As shown, user input 140 can be used in step 206 and 208 in which a user may identify the types of variables to use in the peeling round (e.g., numeric variables, character variables, etc.), limit the number of variables used, the desired property of the best variables, and/or select the best variable according to the user. The best variables and their cutoffs may define a first subpopulation of a total population of computer operations associated with historical data 130.

In step 208, rule generation system 110 determines whether a best variable has resulted from the first peeling round. In some cases, the user's desired set of properties cannot be achieved (e.g., they are too constrictive) and thus rule generation system 110 can determine, at step 208, that the set of properties does not have a potential solution or rule 150. If rule generation system 110 successfully identifies a best variable with its optimal cutoff, then rule generation system 110 retains information to identify the subpopulation of computer operations that is encompassed by that variable and its cutoff (e.g., all the computer operations with variable A less than 300). Rule generation system 110 then checks to see if the maximum number of variables, which can be defined in user input 140, is satisfied in step 212. If additional variables are needed in order to achieve the desired set of properties for rule 150, then rule generation system 110 performs steps 204-212 based on the subpopulation of computer operations that was derived in the previous round. Thus, in various embodiments, rule generation system 110 performs the monotonic binning on the variables (except for the best variables of prior rounds) using the computer operations that fall within the subpopulation and performs another peeling round, resulting in a new subpopulation that is a subset of the subpopulation derived from the prior round-e.g., after the first round, the new subpopulation is defined by two variables and their respective cutoff if there are best variables found. This loop of steps 204-212 is repeated until the maximum number of variables has been reached, or the desired properties can be satisfied by the resulting subpopulation, in some cases. An example of deriving a subpopulation based on multiple variables and their cutoffs is discussed in greater detail with respect to FIG. 5B. When step 212 is satisfied, the final subpopulation is used by rule generation system 110 to create a first subrule in step 214. At the meantime, the computer operations corresponding to the final subpopulation are removed from the entire population in step 216 in preparation for step 218.

In step 218, rule generation system 110 then determines whether the maximum number of subrules, which can be defined in user input 140, has been generated or the desired properties are satisfied by the generated subrule(s). If additional subrules are needed, then rule generation system 110 is redirected to the subrule generation loop (back to step 204) to generate another subrule that is based on the remaining population of computer operations-the remaining population may include those computer operations of historical data 130 that are not encompassed within the subpopulations derived from the generated subrule(s) from the last round. The generation of subrules may be repeated until the maximum number of subrules has been reached or the desired properties are satisfied by the generated subrule(s). If so, rule generation system 110 then generates a full rule 150 in step 220 based on the generated subrule(s)-the generated subrules may be composed using else-if statements. In various embodiments, rule generation system 110 applies, to a full rule 150, a random component or noise to one or more cutoffs to shift their position in the rule 150, aiming to generate alternative rules 150 with potentially improved prediction abilities. In step 222, rule generation system 110 determines whether the maximum number of rules 150, which can be defined in user input 140, has been generated. If additional rules 150 can be generated, then rule generation system 110 can return to the subrule generation loop (back to step 204).

In step 224, all the generated rules 150 that have different combinations of variables and cutoffs are selected by rule generation system 110 and then, in step 226, those rules 150 are compared and scored to select the final recommended rule 150. As a part of step 226, those rules 150 may be applied to previously executed computer operations to evaluate their accuracy and performance with respect to predicting the characteristic(s) for which those rules 150 were generated. If the performance of one particular rule 150 satisfies all user input 140, then rule generation system 110 can provide it as a final recommended rule 150 in step 228.

Rule generation process 200 can be implemented differently than shown. For example, rule generation process 200 may not include step 222; instead, rule generation system 110 may generate only one rule 150 before proceeding to step 226 without making any assessment with regards to the number of generated rules 150. As another example, step 204 may be outside of the subrule generation loop such that step 212 redirects to step 206 instead of step 204. As yet another example, user input 140 may not be received at step 226 and thus a user may not have influence on the comparing and scoring of generated rules 150.

Turning now to FIG. 3, a block diagram of an example preprocess module 112 is shown. In the illustrated embodiment, preprocess module 112 includes a variable extraction module 310 and a variable selection module 320. In some embodiments, preprocess module 112 is implemented differently than shown. As an example, preprocess module 112 may not receive user input 140 and utilize it to generate computer operation data 330.

Variable extraction module 310, in various embodiments, is software that is executable to extract or otherwise identify variables from historical data 130. As discussed, historical data 130 describes previously executed computer operations, such as computer operations executed by computer operation system 120 and may be accessed from a database by preprocess module 112. In some cases, historical data 130 may be records corresponding to rows in a table having columns defining fields for that table. As such, variable extraction module 310 may designate the fields as variables under which the records provide values. In some embodiments, variable extraction module 310 derives variables from existing variables. As an example, a model score variable might be generated by a machine learning model based on multiple fields of historical data 130 and thus the value for the model score of a record may be generated using the machine learning model and the values of those fields of that record. In various embodiments, variable extraction module 310 utilizes user input 140 to identify variables from historical data 130—a user may select variables or types of variables to use. In some cases, historical data 130 may include labels for different pieces of information that designate variables. As an example, the CPU usage involved in executing a computer operation might be labeled under a CPU usage variable.

In various embodiments, in addition to extracting variables, variable extraction module 310 performs normalization and high missing deletion techniques on historical data 130. To normalize historical data 130, variable extraction module 310 may transform the variables to have a similar scale. For example, a numerical variable with higher numerical values may have greater influence on a predictive model than a variable with lower numerical values. As such, variable extraction module 310 may adjust and scale the higher numerical values proportionally to reflect similar numerical values when compared to the lower numerical values to ensure both variables have relatively equal influence when predicting characteristics of computer operations. Also, as a part of normalizing historical data 130, variable extraction module 310 may ensure that values referring to the same element have the same format—e.g., the value NY is transformed to New York. As a part of performing high missing deletion, variable extraction module 310 may identify and remove computer operations or variables having a high percentage of missing values (the threshold of “high” in terms of the missing rate can be identified from user's input 140). After extracting or identifying variables, variable extraction module 310 may provide historical data 130 with normalized and low-missing variables and information about those variables to variable selection module 320.

Variable selection module 320, in various embodiments, is software that is executable to select variables to be used in generating rules 150 based on their determined relevance in satisfying user input 140. For example, a user may wish to predict whether a computer request will timeout, and thus variable selection module 320 may select variables that are determined to be relevant for predicting this characteristic. To select the variables, in various embodiments, variable selection module 320 performs the selection based on different measurements, including population stability index (PSI) and information value (IV), etc.

Population stability index (PSI) compares the distribution of a variable from historical data 130 to the distribution of the same variable in a new dataset or a theoretical distribution. Population stability index measures how the distribution of a variable in a population has shifted over a period of time. If a population stability index's score is equal to zero, there is no difference on in the distribution of a variable in two datasets. A PSI score greater than zero indicates that a difference exists, and a higher score is equated with a greater degree of difference for the variable between two datasets. A variable with a high PSI score may not be an ideal candidate for prediction. As such, variable selection module 320 may select only those variables associated with a PSI score that is below a particular PSI threshold (e.g., PSI<0.15).

Information value (IV) is used to select one or more variables by scoring each variable based on the relevance and predictive power of the variable. IV is determined using weight of evidence (WOE) and a percentage value that represents the difference between the number of computer operations exhibiting a specific characteristic and the number of computer operations that do not exhibit the same characteristic within a total number of computer operations in a particular group determined by variable values. For example, 7% of all database transactions may exhibit high resource usage while the remaining 93% do not exhibit this characteristic. resulting in a difference in value of 86%. WOE is a numerical value that represents the likelihood of observing a characteristic in the group of computer operations and can be a positive or negative value. The product of WOE and difference in percentages creates an IV score for the variable. For example, a variable with a lower score has less predictive power and is not a useful candidate for modeling or rule generation. The variable selection module 320, in various embodiments, selects only those variables associated with an IV score that is higher than a particular IV threshold (e.g., IV>0.3).

In some embodiments, variable selection module 320 selects variables based on the selection criteria provided in user input 140. Variable selection module 320 may also select variables based on the propensity to be monotonically binned. For example, a numerical variable whose data is predicted to form a “U” shape when binned with respect to a characteristic may not be selected. The specific techniques used may depend on the nature of historical data 130 and user input 140. After selecting variables that are highly relevant to predict the characteristics of computer operations, variable selection module 320 provides computer operation data 330 to monotonic binning module 114 that identifies those variables and may include the preprocessed historical data 130.

Turning now to FIG. 4A, chart diagrams pertaining to an example of monotonic binning are shown. The monotonic binning function may address various data issues such as the missing data handling, outlier removing, and serves as an interpretable tool to enhance the understanding of the nonlinear dependence between the variable and the characteristic. It serves as a principal function to maximize differentiation between the observation with different characteristics. As explained, in various embodiments, monotonic binning module 114 generates bins 430 into which computer operations 400 of computer operation data 330 are placed based on their value for a variable 420 such that, when those computer operations 400 are placed into those bins 430, a prevalence of a characteristic 410 monotonically increases or decreases from bin to bin across a bin ordering that is based on ranges 440 of those bins 430. In the illustrated embodiment, the top chart diagram shows computer operations 400 placed in bins 430 before the monotonic binning operation has generated or otherwise adjusted those bins 430 such that the monotonic increasing/decreasing property is observed. The bottom chart diagram of FIG. 4A shows computer operations 400 placed into bins 430 after the monotonic binning operation has completed-a monotonic decreasing property is observed.

Monotonic binning module 114 initially may receive computer operation data 330 from preprocess module 112. As discussed, in various embodiments, computer operation data 330 describes a selected set of variables 420 and computer operations 400 to be used in a monotonic binning operation as part of generating rules 150. Accordingly, monotonic binning module 114 may perform the monotonic binning operation on a portion or all of the selected set of variables 420, including the illustrated variable 420. In some embodiments, variable 420 is divided into preliminary bins 430 having ranges 440 that are of equal (or roughly equal) width or quantile. In particular, monotonic binning module 114 may determine the entire range (that is, the lower and upper bound values) of variable 420 based on the associated values of computer operations 400. That entire value range may then be divided into equal (or roughly equal) ranges 440. In various embodiments, a machine learning model is trained, using supervised machine learning techniques, based on training data having executed computer operations 400 and generated bins 430 that yield the monotonic property when those executed computer operations 400 are placed in those bins 430. Accordingly, monotonic binning module 114 may utilize the machine learning model to generate bins 430 for variable 420 based on computer operations 400 of the received computer operation data 330.

As shown in the before monotonic binning chart diagram, variable 420 is divided into preliminary bins 430, including a preliminary bin 430A that has a range 440A of (0.089, 026], that are organized in a particular order (e.g., ascending order). The amount or percentage of computer operations 400 that exhibit characteristic 410 with respect to a given bin 430 can be observed based on the placement of those computer operations 400 into those bins 430. As shown for example, bin 430A includes nearly a thousand computer operations 400 that have values for variable 420 that fall into range 440A (i.e., (0.089, 0.26]), and around 4.2% of those computer operations 400 of bin 430A exhibit characteristic 410. In contrast, bin 430B includes nearly two thousand computer operations 400 that have values for variable 420 that fall into a range of (0.87, 1.0]), and around 0.4% of those computer operations 400 exhibit characteristic 410. As shown, bins 430 used in the top chart do not cause a monotonic relationship to occur as the prevalence of characteristic 410 increases in some cases while also decreasing in other cases from bin to bin according to the bin ordering of the top chart.

After generating a set of bins 430 or combining and adjusting ranges 440 of a previous set of bins 430, in various embodiments, monotonic binning module 114 transforms the relationship between the prevalence of characteristic 410 and the set of bins 430 such that the prevalence of characteristic 410 monotonically increases or decreases from bin to bin across a bin ordering based on ranges 440. If a monotonic relationship is successfully formed, then monotonic binning module 114 may retain information about that set of bins 430 and proceed to the next variable 420 in the set of selected variables 420 (if applicable). (If monotonic binning module 114 has finished performing the binning operation on the selected set of variables 420, then it may provide, to rule module 116, the information about variables 420 and their generated bins 430). But if a monotonic relationship cannot be successfully formed, then monotonic binning module 114 may generate another set of bins 430, which can involve combining and adjusting ranges 440 of the previous set of bins 430.

In various embodiments, monotonic binning module 114 combines and adjusts ranges 440 of bins 430 to generate bins 430 that cause the desired monotonic property using machine learning algorithms. As shown for example, range 440A of bin 430A and its neighboring ranges 440 are combined into a new bin 430C that has a range 440B. In some embodiments, monotonic binning module 114 regroups the raw bins of computer operations 400 that are deemed outliers and cause a considerable shift in the prevalence of characteristic 410 between two particular bins 430. The machine learning model may be reapplied to generate a new set of bins 430. Monotonic binning module 114, in some embodiments, repeats the monotonic binning operation until either a monotonic relationship is achieved, or it is determined that one cannot be achieved. But, in various embodiments, preliminary bins 430 are not generated and instead, computer operation data 330 is prepared (e.g., the groups of computer operations 400 are removed) and then used with the machine learning model to generate a set of bins 430 that cause the desired monotonic property in one round.

As shown, bins 430 that are used in the bottom chart do demonstrate a monotonic relationship to occur as the prevalence of characteristic 410 never increases from bin 430C to bin 430D—a monotonically decreasing property is observed. While contiguous ranges 440 are shown, in some cases, variable 420 may be a variable that has values that do not form contiguous ranges 440, such as a character variable. Each potential value that may occur for a character variable 420 is assigned a bin 430 and the resulting bins 430 are sorted such that, when the appropriate computer operations 400 are placed into the resulting bins 430, the prevalence of characteristic 410 monotonically increases or decreases from bin to bin. As an example, a variable 420 may be used to specify the location (e.g., US state) in which a computer operation 400 is performed and thus a given bin 430 of a total set of bins 430 may correspond to a possible location (e.g., a particular US state).

As one example, the monotonic binning process may be applied to a particular variable 420 corresponding to the transaction amount involved in a given payment transaction between entities. Characteristic 410 may correspond to fraud and thus a payment transaction (a type of computer operation 400) exhibits characteristic 410 in this example if it is fraudulent. As such, monotonic binning module 114 may generate bins 430 having ranges 440, a given one of which is a range of transaction amounts. It may be the case that fraud is more prevalent in lower value payment transactions than higher value payment transactions. Consequently, bins 430 may be generated such that, when the payment transactions are placed into the resulting bins 430 based on their transaction amounts, the prevalence or rate of fraud decreases from bin to bin across the resulting bins 430 when they are ordered by transaction amounts of their ranges 440 in an increased ordering. As an example, bin 430C may have the highest fraud rate while bin 430D may have the lowest fraud rate.

Turning now to FIG. 4B, chart diagrams that pertain to another example of monotonic binning are shown. In FIG. 4A, variable 420 exhibits a monotonically decreasing relationship with characteristic 410 across bins 430. In contrast, as shown in FIG. 4B, variable 420 exhibits a monotonically increasing relationship with characteristic 410 across bins 430. In particular, a given variable 420 may be prone to exhibiting either an increasing or decreasing monotonic relationship with characteristic 410. In various embodiments, monotonic binning module 114 can perform the monotonic binning operation on the given variable 420 independent of whether it is prone to exhibiting an increasing or decreasing monotonic relationship with characteristic 410. Monotonic binning module 114 may automatically detect the general relationship between variable 420 and the prevalence of characteristic 410, and then transform with bins 430 to satisfy the monotonicity constraints.

Turning now to FIG. 5A, a block diagram of an example rule module 116 is shown. In the illustrated embodiment, rule module 116 includes cutoff optimization module 118, a rule optimizer module 520, and a rule test module 530. In some embodiments, rule module 116 is implemented differently than shown. For example, rule test module 530 may be implemented separately from rule module 116.

Cutoff optimization module 118, in various embodiments, is software that is executable to determine one or more cutoffs for one or more variables 420 included in binning data 510 (having information about variables 420 and bins 430) received from monotonic binning module 114. Those cutoffs of the variables 420 may then be used to generate subrules and rules 150. In some embodiments, a cutoff is determined for a binned variable based on user input 140 and/or the bin boundaries of that variable's bins 430. User input 140 can include a set of desired properties for rules 150, specified by a user using a user interface, that influences the performance of cutoff optimization module 118. For example, a user may determine the maximum number of variables, a desired correct prediction rate, and a maximum acceptable false positive rate (FPR) used in generating one or more rules 150. False positive rate (FPR) is a value that represents the number of computer operations falsely predicted to have specific characteristic out of a total number of predictions performed by a particular rule 150—e.g., a user might request that a particular rule 150 be generated with a false positive rate less than 3% of predicting whether a computer operation will exhibit a particular characteristic 410. In various cases, cutoff optimization module 118 uses a combination of cutoffs to generate a subrule (that represents a sub-population of a total population) as part of a generating a particular rule 150, as was discussed with respect to FIG. 2. An example of the process for cutoff optimization module 118 is discussed in greater detail with respect to FIG. 5B.

If additional sub-rules are needed to satisfy user input 140, cutoff optimization module 118 may use the remaining population of computer operations (absent the subpopulation covered by the subrule) and generate another set of cutoffs until a second subrule is created (steps 204-218 of FIG. 2). Cutoff optimization module 118, in various embodiments, repeats the process to generate subrules until the generated subrules collectively satisfy user input 140. In some cases, a user may select the number of subrules generated by cutoff optimization module 118, and the subrule generation process repeats until the specified number of subrules is reached. After generating the subrules, cutoff optimization module 118 may provide the subrules to rule optimizer module 520. In some embodiments, cutoff optimization module 118 generates complete rules 150 and provides them to rule optimizer module 520.

Rule optimizer module 520, in various embodiments, is software that is executable to attempt to derive a potentially more optimal rule 150 by assigning a random component to one or more cutoffs to shift the cutoff value in a random direction to create an alternate subrule or rule 150. For example, by shifting one or more cutoffs of a particular rule 150, the correct prediction rate of that particular rule 150 may increase, or in some cases, the FPR of that rule 150 decrease. A user may select the maximum number of alternate subrules or rules 150 for rule optimizer module 520 to attempt to find the optimal combination of cutoffs of all selected variables from binned data 510. An example of this process is discussed in greater detail with respect to FIG. 5C. After the desired number of rules 150 is created, those rule 150 may be provided to rule test module 530.

Rule test module 530, in various embodiments, is software that is executable to score the performance of one or more rules 150 by applying those rules 150 to previously executed computer operations, with some exhibiting characteristic 410, and observing the predictions of those rules 150. Those previously executed computer operations may correspond to a portion of the computer operations of historical data 130 that were not used in the generation of those rules 150. Rule test module 530 may then compare scores between rules 150 and suggest one or more rules 150 that best satisfies user input 140. A user, in various embodiments, may apply domain knowledge to select a given rule 150 to use to perform predictions.

Turning now to FIG. 5B, a block diagram of a cutoff searching process that is performed by cutoff optimization module 118 is shown. In the illustrated embodiment, there are three rounds in which cutoffs 540A-C of a given variable 420 are determined-the number of rounds may correspond to the maximum number of variables 420 that can be used in a subrule as specified in user input 140. In various embodiments, for a given round, cutoff optimization module 118 determines, for one or more variables 420, a cutoff 540 that is based on bins 430 that were generated for the respective variable 420. In various embodiments, cutoff optimization module 118 uses a hill climbing approach in which it begins with an arbitrary cutoff 540 for a variable 420 and then attempts to find a better cutoff 540 by making an incremental improvement in terms of achieving the desired properties of rule 150. If the optimization process finds a cutoff 540, then cutoff optimization module 118 repeats the process based on the subpopulation hit by that cutoff 540 of variable 420. But if a better cutoff 540 is not produced, then cutoff optimization module 118 repeats the process with the arbitrary cutoff 540 and a different incremental change. That cutoff 540 may be selected to correspond to the boundary between two particular bins 430 and may be further selected to balance between two or more constraints specified in user input 140. As an example, the position of a cutoff 540 may be selected for a variable 420 such that a condition derived from that cutoff 540 and that variable 420 has at least correct prediction rate threshold and less than a false positive rate threshold.

In various cases, cutoffs 540 are determined for multiple variables 420 and cutoff optimization module 118 selects the variable 420 that best satisfies the user's desired set of properties. In the initial round within the illustrated embodiment, cutoff optimization module 118 selects a cutoff 540A for Score_1 (Score_1 is one of the input model scores included in variables 420), resulting in subpopulation “I” of a total population of computer operations 400. Subpopulation I includes the computer operations having a value for Score_1 that is greater than or equal to cutoff 540A. If subpopulation I does not satisfy user input 140, then cutoff optimization module 118 may retain subpopulation I and another round for a better cutoff is performed. For example, all computer operations that fall within subpopulation I may be rejected, but that may result in too many valid computer operations being rejected (a high false positive rate) and thus user input 140 may not be satisfied-a user may specify an acceptable false positive rate. Thus, cutoff optimization module 118 may perform another around in which subpopulation I is reduced to a smaller subpopulation to satisfy the above user's input. The additional round can include rebinning the remaining variables based on the computer operations that fall within subpopulation I.

In the second round in the illustrated embodiment, cutoff optimization module 118 selects a cutoff 540B for Score_2 (Score_2 is another one of the input model scores in variables 420) and based on subpopulation I, resulting in a subpopulation “II.” Subpopulation II includes those computer operations having a value for Score_1 that is greater than or equal to cutoff 540A and a value for Score_2 that is greater than or equal to cutoff 540B. If subpopulation II does not satisfy user input 140, then cutoff optimization module 118 retains subpopulation II and another round is performed, which can include rebinning the remaining variables based on the computer operations that fall within subpopulation II.

In the third round in the illustrated embodiment, cutoff optimization module 118 selects a third cutoff 540C for Var_1 (Var_1 is one of the input numeric variable in variables 420) and based on subpopulation II, resulting in subpopulation “III.” Subpopulation III includes those computer operations having a value for Score_1 that is greater than or equal to cutoff 540A, a value for Score_2 that is greater than or equal to cutoff 540B, and a value for Var_1 is less than or equal to cutoff 540C. If the subrule that defines subpopulation III satisfies user input 140, then then the cutoff searching process is stopped and the subrule may be provided as a particular rule 150. If the maximum number of variables 420 has been used and the particular subrule does not satisfy user input 140, then another subrule may be required and created from the remaining population (i.e., the total population minus subpopulation III). Subrules may be generated until an aggregate of those subrules forms a particular rule 150 that satisfies user input 140.

Turning now to FIG. 5C, a block diagram of an example optimization process that can be performed by rule optimizer module 520 is shown. To attempt to improve a subrule or a rule 150, in various embodiments, rule optimizer module 520 assigns shift in the form of adding a random component to the subrule/rule's cutoff 540. As shown, cutoff 540A shifts to a new position based on the randomly assigned probability, resulting in a new cutoff 540A′ by adding a new subpopulation I (ε). As shown, subpopulation I is now defined by cutoff 540A′. If multiple cutoffs exist, then rule optimizer module 520, in various embodiments, assigns a shift with a random component to each cutoff. As shown, rule optimizer module 520 add a second random component to second cutoff 540B, resulting in cutoff 540B′. As shown, subpopulation II is now defined by cutoff 540A′ and cutoff 540B′ by removing the subpopulation II (ε). Rule optimizer module 520 may repeat the process to generate new alternative rules 150 until the maximum number of alternate rules is achieved as specified by user input 140.

Turning now to FIG. 6, a block diagram in which an example rule 150 is used by system 100 is shown. In the illustrated embodiment, system 100 includes rule generation system 110, rule 150, and computer operation system 120 (having rule applier module 122). As shown, rule generation system 110 provides rule 150 to computer operation system 120 for generating a prediction 610 in response to a computer operation request 160. In some embodiments, system 100 is implemented differently than shown. For example, multiple rules 150 may be provided to computer operation system 120, or rule generation system 110 may generate prediction 610 instead of computer operation system 120.

Rule applier module 122, in various embodiments, is software executable to apply rule 150 to generate prediction 610 for a computer operation 400 that may be requested in computer operation request 160. As shown, rule 150 specifies multiple predicates or criteria. In various embodiments, if all the criteria are satisfied by the requested computer operation 400, then rule applier module 122 generates prediction 610 to indicate that the requested computer operation 400 will exhibit the one or more characteristics 410 for which rule 150 was generated. If those one or more characteristics 410 are not desirable, then rule applier module 122 can prevent that requested computer operation 400 from being executed. For example, if a database transaction is predicted to fail, then it can be prevented from being executed by computer operation system 120. As another example, if a payment transaction is predicted to be fraudulent since its values for the variables in rule 150 satisfy the criteria, then it can be prevented from being executed by computer operation system 120.

If one or more of the criteria are not satisfied by the requested computer operation 400, then rule applier module 122 generates prediction 610 to indicate that the requested computer operation 400 will not exhibit the one or more characteristics 410. Depending on whether the one or more characteristics 410 are desirable, rule applier module 122 can allow or prevent the execution of the requested computer operation 400. For example, if a computer operation 400 is associated with the value “110” for the variable “var_1,” then because it does not satisfy the predicate “var_1>115,” it is not predicted to exhibit the one or more characteristics 410. But in some embodiments, prediction 610 can indicate a percentage or likelihood that a computer operation 400 will exhibit the one or more characteristics 410 based on which and how many of the one or more criteria of rule 150 are satisfied. For example, rule 150 may be used by rule applier module 122 to generate prediction 610 to indicate whether a new database transaction will exceed a particular system resource threshold before the transaction is executed. The new database transaction may satisfy all the criteria of rule 150 except for “var_3.” As a result, the new database transaction may be predicted to likely exhibit the one or more characteristics 410 since it satisfies most of the criteria of rule 150.

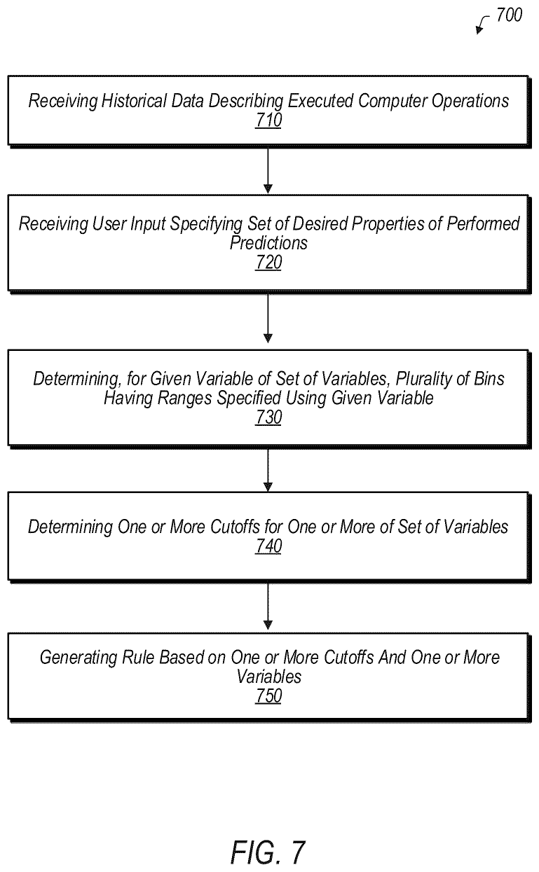

Turning now to FIG. 7, a flow diagram of a method 700 is shown. Method 700 is one embodiment of a method that is performed by a computer system (e.g., rule generation system 110) to generate a rule (e.g., a rule 150) for performing predictions of a characteristic (e.g., a characteristic 410) of computer operations (e.g., computer operations 400). Method 700 may be performed by executing program instructions stored on a non-transitory computer-readable medium. Method 700 may include more or less steps than shown. For example, method 700 may include a step in which the rule is provided to another computer system (e.g., computer operation system 120) that is operable to determine whether to perform a computer operation based on whether the rule indicates that the computer operation exhibits the characteristic.

Method 700 begins in step 710 with the computer system receiving historical data (e.g., historical data 130) describing executed computer operations, including variables (e.g., variables 420) that are associated with the executed computer operations and outcomes of the executed computer operations. The variables may include one or more model scores that are generated by one or more machine learning models based on the executed computer operations. In step 720, the computer system receives user input (e.g., user input 140) specifying a set of desired properties of performed predictions and constraints applied on the rule generation process. The set of desired properties may include that a false positive rate (FPR) of the rule predicting the characteristic does not exceed a FPR threshold value and that a correct prediction rate of the rule predicting the characteristic satisfies a correctness threshold value. The constraints may include the number of variables used for each subrule, the number of subrules, the threshold to desired properties (i.e., FPR is less than 3%).

In step 730, the computer system determines, for a given variable of a set of the received variables, a plurality of bins (e.g., bins 430) having ranges (e.g., ranges 440) specified using the given variable. In various embodiments, the plurality of bins are determined such that, when the executed computer operations are grouped into the plurality of bins, a prevalence of the characteristic monotonically increases or decreases from bin to bin across a bin ordering that is based on the ranges. For example, the prevalence of characteristic 410 shown in FIG. 4B monotonically increases from bin to bin across a bin ordering that is based on the ranges shown in FIG. 4B. In various embodiments, the set of the received variables may be derived based on the historical data. The deriving may include determining, for the received variables associated with the executed computer operations, a plurality of metrics that includes an information value metric and a population stability index metric. Based on the plurality of metrics, the computer system may select, from the variables, a set as candidate variables for generating the rule.

In step 740, the computer system determines one or more cutoffs (e.g., cutoffs 540) for one or more of the set of variables. A cutoff may be determined for the given variable based on the set of desired properties and the plurality of bins. In various embodiments, the cutoff is determined such that the cutoff corresponds to the edge between two particular bins of the plurality of bins in the bin ordering.

In step 750, the computer system generates the rule based on the one or more cutoffs and the one or more variables. In some cases, the generating of the rule includes generating a subrule that incorporates at least one of the one or more variables and that variable's corresponding cutoff of the one or more cutoffs. Based on determining that the subrule includes a maximum number of variables allowed in a subrule as specified by the user input, the computer system may generate a set of additional subrules that incorporate different sets of variables and cutoffs than the subrule. The computer system may generate subrules for the set of additional subrules until an aggregation of the subrule and the set of additional subrules satisfies the set of desired properties based on predictions produced by the aggregation. The computer system may then aggregate the subrule and the set of additional subrules to generate the rule.

In various embodiments, the computer system generates one or more additional rules based on the rule. In some cases, the generating of a given one of the one or more additional rules includes adjusting at least one cutoff used in the rule. In some cases, a given one of the one or more additional rules is generated based on different combinations of the variables and cutoff. In some embodiments, the computer generates rules for the set of additional rules until a maximum number of rules is generated, and the maximum number may be specified by the user input. The computer system may select, from the rule and the one or more additional rules, a particular rule to use to perform predictions of the characteristic.

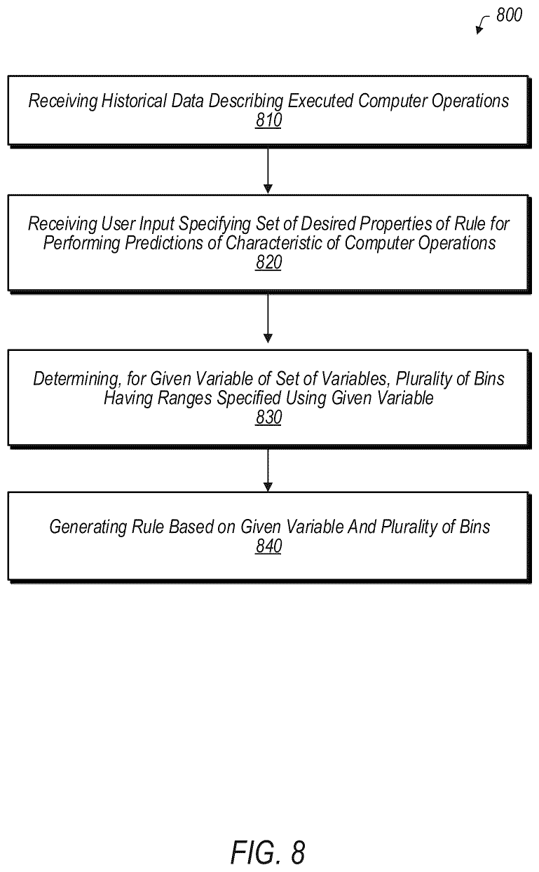

Turning now to FIG. 8, a flow diagram of a method 800 is shown. Method 800 is one embodiment of a method that is performed by a computer system (e.g., rule generation system 110) to generate a rule (e.g., a rule 150) for performing predictions of a characteristic (e.g., a characteristic 410) of computer operations (e.g., computer operations 400). Method 800 may be performed by executing program instructions stored on a non-transitory computer-readable medium. Method 800 may include more or less steps than shown. For example, method 800 may include a step in which the rule is provided to another computer system (e.g., computer operation system 120) that is operable to determine whether to perform a computer operation based on whether the rule indicates that the computer operation exhibits the characteristic.

Method 800 begins in step 810 with the computer system receiving historical data (e.g., historical data 130) describing executed computer operations, including variables (e.g., variables 420) that are associated with the executed computer operations. In step 820, the computer system receives user input (e.g., user input 140) specifying a set of desired properties of the rule for performing predictions of a characteristic of computer operations.

In step 830, the computer system determines, for a given variable of a set of the received variables, a plurality of bins (e.g., bins 430) having ranges (e.g., ranges 440) specified using the given variable. In various embodiments, the plurality of bins are determined such that, when the executed computer operations are grouped into the plurality of bins, a prevalence of the characteristic monotonically increases or decreases from bin to bin across a bin ordering that is based on the ranges. Before the determining of the plurality of bins, the computer system may perform a preprocessing operation to select, from the variables, candidate variables for generating the rule. The preprocessing operation can include determining, for a plurality of the variables, a plurality of metrics that includes an information value metric and a population stability index metric and then, based on the plurality of metrics, selecting, from the variables, candidate variables to include in the set of variables.

In step 840, the computer system generates the rule based on the given variable and the plurality of bins. The computer system may determine, for the given variable, a cutoff that is indicative of a subset of the plurality of bins and then use that cutoff as a part of generating the rule. The rule may include a condition for the given variable that is satisfied by a computer operation that bins into one of the subset of bins. In some embodiments, the computer system generates one or more additional rules based on different combinations of the variables and cutoffs and then selects, from the rule and the one or more additional rules, a particular rule that best satisfies the set of desired properties among the one or more additional rules and the frule. The computer system may receive a request to perform a computer operation and then predict, based on the rule and the computer operation, that the computer operation will exhibit the characteristic. Based on the predicting, the computer system may prevent performance of the computer operation.

### Exemplary Computer System

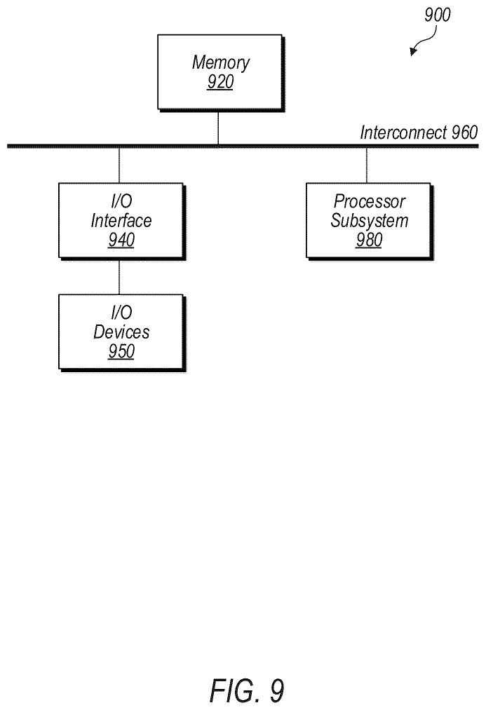

Turning now to FIG. 9, a block diagram of an exemplary computer system 900, which may implement system 100, rule generation system 110, and/or computer operation system 120, is depicted. Computer system 900 includes a processor subsystem 980 that is coupled to a system memory 920 and I/O interfaces(s) 940 via an interconnect 960 (e.g., a system bus). I/O interface(s) 940 is coupled to one or more I/O devices 950. Although a single computer system 900 is shown in FIG. 9 for convenience, system 900 may also be implemented as two or more computer systems operating together.

Processor subsystem 980 may include one or more processors or processing units. In various embodiments of computer system 900, multiple instances of processor subsystem 980 may be coupled to interconnect 960. In various embodiments, processor subsystem 980 (or each processor unit within 980) may contain a cache or other form of on-board memory.

System memory 920 is usable store program instructions executable by processor subsystem 980 to cause system 900 perform various operations described herein. System memory 920 may be implemented using different physical memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 900 is not limited to primary storage such as memory 920. Rather, computer system 900 may also include other forms of storage such as cache memory in processor subsystem 980 and secondary storage on I/O Devices 950 (e.g., a hard drive, storage array, etc.). In some embodiments, these other forms of storage may also store program instructions executable by processor subsystem 980. In some embodiments, program instructions that when executed implement preprocess module 112, monotonic binning module 114, rule module 116, cutoff optimization module 118, and rule applier module 122 may be included/stored within system memory 920.

I/O interfaces 940 may be any of various types of interfaces configured to couple to and communicate with other devices, according to various embodiments. In one embodiment, I/O interface 940 is a bridge chip (e.g., Southbridge) from a front-side to one or more back-side buses. I/O interfaces 940 may be coupled to one or more I/O devices 950 via one or more corresponding buses or other interfaces. Examples of I/O devices 950 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 900 is coupled to a network via a network interface device 950 (e.g., configured to communicate over WiFi, Bluetooth, Ethernet, etc.).

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112 (f) for that claim element. Should Applicant wish to invoke Section 112 (f) during prosecution of a United States patent application based on this disclosure, it will recite claim elements using the “means for” [performing a function] construct.

What is claimed is:

1. A method for generating a rule for performing predictions of a characteristic of computer operations, the method comprising:
a computer system receiving:
historical data describing executed computer operations, including variables that are associated with the executed computer operations and outcomes of the executed computer operations; and
user input specifying a set of desired properties of performed predictions;
the computer system determining, for a given variable of a set of the variables, a plurality of bins having ranges specified using the given variable, wherein the plurality of bins are determined such that, when the executed computer operations are grouped into the plurality of bins, a prevalence of the characteristic monotonically increases or decreases from bin to bin across a bin ordering that is based on the ranges;
the computer system determining one or more cutoffs for one or more of the set of variables, wherein a cutoff is determined for the given variable based on the set of desired properties and the plurality of bins; and
the computer system generating the rule based on the one or more cutoffs and the one or more variables.

2. The method of claim 1, wherein the generating of the rule includes:
generating a subrule that incorporates at least one of the one or more variables and that variable's corresponding cutoff of the one or more cutoffs;
based on determining that the subrule includes a maximum number of variables allowed in a given subrule as specified by the user input, generating a set of additional subrules that incorporate different sets of variables and cutoffs than the subrule; and
aggregating the subrule and the set of additional subrules to generate the rule.

3. The method of claim 2, wherein the computer system is operable to generate subrules for the set of additional subrules until an aggregation of the subrule and the set of additional subrules satisfies the set of desired properties based on predictions produced by the aggregation.

4. The method of claim 1, further comprising:
the computer system generating one or more additional rules based on the rule, wherein generating of a given one of the one or more additional rules includes adjusting at least one cutoff used in the rule; and
the computer system selecting, from the rule and the one or more additional rules, a particular rule to use to perform predictions of the characteristic.

5. The method of claim 1, further comprising:
the computer system generating a set of additional rules for performing predictions of the characteristic, wherein the set of additional rules is generated based on different combinations of the variables and cutoffs; and
the computer system selecting, from the rule and the set of additional rules, a particular rule to use to perform predictions of the characteristic.

6. The method of claim 5, wherein the computer system is operable to generate rules for the set of additional rules until a maximum number of rules is generated, and wherein the maximum number of rules is specified by the user input.

7. The method of claim 1, wherein the cutoff for the given variable is determined such that the cutoff corresponds to an edge between two bins of the plurality of bins in the bin ordering.

8. The method of claim 1, wherein the variables include one or more model scores generated by one or more machine learning models based on the executed computer operations.

9. The method of claim 1, wherein the set of desired properties include that a false positive rate (FPR) of the rule predicting the characteristic does not exceed a FPR threshold value and that a correct prediction rate of the rule predicting the characteristic satisfies a correctness threshold value.

10. The method of claim 1, further comprising:
the computer system providing the rule to an external computer system that is operable to determine whether to perform a computer operation based on whether the rule indicates that the computer operation exhibits the characteristic.

11. A non-transitory computer-readable medium having program instructions stored thereon that are executable to cause a computer system to perform operations comprising:
receiving historical data describing executed computer operations;
receiving user input specifying a set of desired properties of a rule for performing predictions of a characteristic of computer operations;
based on the historical data, deriving a plurality of variables associated with the executed computer operations, wherein a particular one of the plurality of variables is usable to perform a prediction of the characteristic of a computer operation;
determining, for the particular variable, a plurality of bins having ranges specified using the particular variable, wherein the plurality of bins are determined such that, when the executed computer operations are grouped into the plurality of bins, a prevalence of the characteristic monotonically increases or decreases from bin to bin across a bin ordering that is based on the ranges;
determining, for the particular variable, a cutoff based on the plurality of bins and the set of desired properties; and
generating the rule that incorporates one or more of the plurality of variables and one or more corresponding cutoffs, wherein the rule incorporates the particular variable and the cutoff.

12. The non-transitory computer-readable medium of claim 11, wherein the generating of the rule includes:
generating a subrule by incorporating ones of the plurality of variables and corresponding cutoffs into the subrule until the subrule satisfies the set of desired properties or includes a specified maximum number of variables; and
in response to determining that the subrule includes the specified maximum number of variables but does not satisfy the set of desired properties, generating additional subrules until the subrule and the additional subrules collectively satisfy the set of desired properties, wherein the additional subrules incorporate different sets of variables with different pluralities of bins and cutoffs than the subrule.

13. The non-transitory computer-readable medium of claim 11, wherein the generating of the rule includes:
generating one or more additional rules that incorporate the particular variable, wherein at least one of the one or more additional rules includes a different cutoff with respect to the particular variable than the cutoff used in the rule; and
selecting, from the rule and the one or more additional rules, a particular rule that best satisfies the set of desired properties.

14. The non-transitory computer-readable medium of claim 11, wherein the operations further comprise:
generating one or more additional rules for performing predictions of the characteristic, wherein the one or more additional rules are generated based on different combinations of the variables and cutoffs;
receiving a user selection of a particular one of the rule and the one or more additional rules based on the user input; and
providing the particular rule to an external computer system that is operable to determine whether to perform a computer operation based on whether the particular rule indicates that the computer operation exhibits the characteristic.

15. The non-transitory computer-readable medium of claim 11, wherein the deriving of the plurality of variables includes:
determining, for a set of variables associated with the executed computer operations, a plurality of metrics that includes an information value metric and a population stability index metric; and
based on the plurality of ranking metrics, selecting, from the set of variables, the plurality of variables as candidate variables for generating the rule.

16. A system, comprising:
at least one processor; and
a memory having program instructions stored thereon that are executable by the at least one processor to cause the system to perform operations comprising:
receiving historical data describing executed computer operations, including variables that are associated with the executed computer operations; and
receiving user input specifying a set of desired properties of a rule for performing predictions of a characteristic of computer operations;
determining, for a given variable of a set of the variables, a plurality of bins having ranges specified using the given variable, wherein the plurality of bins are determined such that, when the executed computer operations are grouped into the plurality of bins, a prevalence of the characteristic monotonically increases or decreases from bin to bin across a bin ordering that is based on the ranges; and
generating the rule based on the given variable and the plurality of bins.

17. The system of claim 16, wherein the generating includes:
determining, for the given variable, a cutoff that is indicative of a subset of the plurality of bins, wherein the rule includes a condition for the given variable that is satisfied by a computer operation that bins into one of the subset of bins.

18. The system of claim 16, wherein the operations further comprise:
generating one or more additional rules based on different combinations of the variables and cutoffs; and
selecting, from the rule and the one or more additional rules, a particular rule that best satisfies the set of desired properties among the one or more additional rules and the rule.

19. The system of claim 16, wherein the operations further comprise:
before the determining of the plurality of bins, performing a preprocessing operation to select, from the variables, candidate variables for generating the rule, wherein the preprocessing operation includes:
determining, for a plurality of the variables, a plurality of metrics that includes an information value metric and a population stability index metric; and
based on the plurality of ranking metrics, selecting, from the variables, candidate variables to include in the set of variables.

20. The system of claim 16, wherein the operations further comprise:
receiving a request to perform a particular computer operation;
predicting, based on the rule and the particular computer operation, that the particular computer operation will exhibit the characteristic; and
based on the predicting, preventing performance of the particular computer operation.
